(19) United States
(12) Patent Application Publication
(10) Pub. No.: US 2004/0197549 A1
(43) Pub. Date: Oct. 7, 2004

(54) Conductive film, manufactruing method thereof, substrate having the same

(75) Inventors: Hisao Inokuma, Yokohama-shi (JP); Keisuke Abe, Yokohama-shi (JP); Yasuhiro Sanada, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 10/825,126

(22) Filed: Apr. 16, 2004

Related U.S. Application Data
(63) Continuation of application No. PCT/JP02/12710, filed on Dec. 4, 2002.

(30) Foreign Application Priority Data
Dec. 5, 2001 (JP) 2001-371347
Apr. 12, 2002 (JP) 2002-110511

(51) Int. Cl. B32B 9/00

(52) U.S. Cl. 428/325; 427/58; 427/402; 427/553; 428/323; 428/336; 428/689

(57) ABSTRACT

A low-reflectance conductive film and a colored low-reflectance conductive film for improving conductivity, suppressing the lowering of conductivity with time, maintaining the reflectance and abrasion resistance, and having a low reflectance function, manufacturing methods thereof, and a substrate provided therewith are provided. The low-reflectance conductive film is made of at least two films, a conductive film containing therein conductive fine particles and a low-refraction film with a lower refractive index than the conductive film, formed on the conductive film, with a resistance-lowering material being contained in the conductive film. A low-reflectance conductive film manufacturing method for forming a low-reflectance conductive film by coating onto a substrate a conductive film forming coating liquid which contains therein conductive fine particles and then coating a low-refraction film forming coating liquid which contains therein a resistance-lowering material.

### TECHNICAL FIELD

The present invention relates to a conductive film having an electromagnetic wave shielding performance formed on a glass substrate, for example, on a panel of a cathode ray tube.

### BACKGROUND ART

Since a cathode ray tube works at high voltages, static electricity is induced at the surface of a cathode ray tube either when it is turned on or when it is turned off. The static electricity often causes dust to deposit on the surface of a cathode ray tube, reduces the contrast of displayed images, or gives a light but unpleasant electric shock, when the finger directly touches the surface.

In recent years, wave interferences to electronic appliances, as caused by electromagnetic wave noise, have become a social problem. In order to prevent the occurrence of such wave interferences, standards have been prepared and restrictions have been imposed. With respect to the effects of electromagnetic wave noise on the human body, a risk of cutaneous cancer caused by electrostatic charges on the surface of a cathode ray tube, the effects of an electric field of extremely low frequency (ELF) on unborn baby, and other troubles as caused by x-ray, ultraviolet ray or the like, have been considered to be problems in each country. Such problems can be solved by disposing a conductive film within the surface of a cathode ray tube, since electromagnetic wave impinges on the conductive film and an eddy current is induced within the conductive film, so that the electromagnetic wave is reflected by this action. The electromagnetic wave shielding performance to reflect the electromagnetic wave, is represented by the surface resistance value of the conductive film. The lower the surface resistance value, the more the electromagnetic wave shielding performance improved.

The conductive film formed in the above-mentioned manner can be formed not only in optical appliances, but also in appliances for civil use, in particular, TV, and a panel for cathode-ray tube used as computer terminal. However, the above conductive film has problems in the contrast of displayed images, and also in the reflection of external light by the panel surface, so that many studies have been made concerning the prevention of the reflection of the light.

In conventional antireflection methods, for example, as described in JP-A-61-118931, there have been employed, for example, a method of depositing a SiO₂ film with fine ruggedness on the surface of a cathode ray tube to impart an anti-glare effect to the surface thereof, and a method of etching the surface with hydrofluoric acid to provide ruggedness on the surface.

These methods, however, are called non-glare treatment for scattering external light, and essentially are not a method of providing a low-reflection film, and therefore have their limitations in reducing the reflectivity, and in the case of a cathode ray tube or the like, these methods cause a reduction in resolution as well.

In order to solve these problems, for example, as disclosed in JP-A-5-151839, there is proposed a low-reflection conductive film which prevents the reflection of light, utilizing an interference of light, by forming a conductive film on the surface of a cathode ray tube panel, and then forming thereon a low-refraction film with a lower refractive index than the conductive film.

As a method of fabricating such a low-reflection conductive film, conventionally there have been proposed a sputtering method and a CVD method. However, the sputtering method has a problem that large-scale facilities are required and therefore costly, while in the CVD method, the surface of the cathode ray tube is required to be heated to high temperatures of at least 350° C. or above, so that problems are caused that a fluorescent substance in the cathode ray tube is detached and the dimensional accuracy of the cathode ray tube is lowered.

In contrast to these methods, advantageous is a method of forming a conductive film by coating a coating liquid comprising conductive fine particles dispersed in a solvent onto a panel surface of a cathode ray tube, and drying the coating liquid coated, since the cost is low and the film can be formed at low temperatures.

Furthermore, in accordance with the development of the technology of flattening the panel surface of a cathode ray tube in recent years, the flatness of the panel surface has been increased. However, this has resulted in that the thickness of the glass in a peripheral area of the panel largely differs from the thickness of the glass in a central area of the panel. Therefore, there has been employed a method of moderating the differences in the transmittance within the panel surface as caused by the thickness of the glass by increasing the transmittance of the glass. However, in this case, the overall transmittance of the glass increases, so that there are caused evils that the contrast at the time of displaying images is lowered. Such evils can be coped with by forming a coloring coat film on the surface of the glass.

As the conductive fine particles that can be used in the above-mentioned coating method, there are used fine particles of metals and alloys of the metals such as Ag, Au, Pd and Ru, and fine particles of metal oxides such as ITO (tin-doped indium oxide), ATO (antimony-doped tin oxide) and RuO₂. Furthermore, it is requested that a sufficient electromagnetic wave shielding performance be exhibited by use of a material with a lower cost, such as ITO and ATO. However, in order to have a sufficient electromagnetic wave shielding performance exhibited by use of ATO or ITO, the film thickness has to be increased, and when the film thickness is increased, there is a problem that it is difficult to maintain low reflecting properties.

Therefore, as a method of causing a sufficient electromagnetic wave shielding performance to exhibit with a further reduction in the value of the surface resistance of the conductive film, there has been devised a method of irradiating a formed conductive film with light such as ultraviolet light. The above method is disclosed, for instance, in JP-B-60-19610, JP-A-63-314714, and JP-A-11-60278.

In JP-B-60-19610, there is disclosed a method of forming a transparent conductive film, which is characterized in that a coated film composed of an indium compound or the like is irradiated with ultraviolet radiation, and then calcined at high temperatures. An object of this method, however, is directed to the obtaining of a uniform, good dried coated film, and the lowering of the value of the surface resistance of the conductive film is not a primary object.

In JP-A-63-314714, there is disclosed a method of producing a transparent conductive film, which is characterized in that a transparent conductive film is irradiated with ultraviolet radiation for 1 minute or more by use of a lamp which generates ultraviolet radiation to lower the resistance value. With respect to this method, there is a description to the effect that adsorbed oxygen is detached by the irradiation of ultraviolet radiation, whereby the resistance value is lowered. However, this method is not directed to the direct working of ultraviolet radiation on the conductive fine particles to reduce the resistance value.

In JP-A-11-60278, there is disclosed a method of producing a transparent conductive film, which is characterized in that a transparent conductive film is irradiated with ultraviolet radiation, followed by calcinating the film in a non-oxidizing atmosphere. In the non-oxidizing atmosphere, the oxidization of conductive fine particles can be prevented and the conductivity thereof can be increased. However, this method has a problem that the non-oxidizing atmosphere is necessary and much labor is required.

### DISCLOSURE OF THE INVENTION

The present invention has been made to solve the above-mentioned problems, and the objects thereof are to provide a low-reflectance conductive film and a colored low-reflectance conductive film, for improving conductivity, having transparency, maintaining abrasion resistance, and also having a low-reflectance function, methods for producing them, a display apparatus provided with the above-mentioned low- reflectance conductive film and the above-mentioned colored low-reflectance conductive film, a conductive film forming coating liquid for forming the above-mentioned conductive film, and a low-refraction film forming coating liquid for forming the above-mentioned low-reflection conductive film.

The present invention provides a low-reflectance conductive film characterized by comprising at least two films, namely a conductive film which contains conductive fine particles, and a low-refraction film with a lower refractive index than the above-mentioned conductive film, which low-refraction film is formed on the above-mentioned conductive film, with a resistance-lowering material being contained in the above-mentioned conductive film.

The present invention provides a conductive film forming coating liquid which contains therein a solvent, conductive fine particles, and a resistance-lowering material, and a low-refraction conductive film forming coating liquid which contains therein a solvent, a silicon compound, and a resistance-lowering material.

Furthermore, the present invention provides a method of producing a low-reflectance conductive film by coating onto a substrate a conductive film forming coating liquid which contains therein conductive fine particles, and then coating a low-refraction film forming coating liquid which contains therein a resistance-lowering material.

### BEST MODE FOR CARRYING OUT THE INVENTION

Hereinafter, a low-reflectance conductive film (hereinafter referred to as XY film) and a colored low-reflectance conductive film (hereinafter referred to as XYZ film), methods of producing the same, and a substrate provided with the same will be specifically explained.

The XY film of the present invention comprises at least two films, a conductive film containing therein conductive fine particles, and a low-refraction film with a lower refractive index than the conductive film, formed on the conductive film, characterized in that a resistance-lowering material is contained in the conductive film. A film other than the above-mentioned conductive film and low-refraction film may be provided.

The above-mentioned XY film is formed by coating onto a substrate a conductive film forming coating liquid containing therein conductive fine particles (hereinafter referred to as X-coating liquid as well), and then by coating a low-refraction film forming coating liquid containing therein a resistance-lowering material (hereinafter referred to as Y-coating liquid as well). Alternatively, the above-mentioned XY film can be formed by coating onto a substrate an X-coating liquid which contains both the conductive fine particles and the resistance-lowering material, and then by coating the Y-coating liquid.

As the above-mentioned conductive fine particles, metal oxide fine particles or metal fine particles are preferably employed. From the view points of conductivity, chemical utility, and-durability, and others, as the metal oxide fine particles, at least one kind selected from the group consisting of Sn, Sb, In, Zn, Ga, Ru, Al, Si and Zr is preferable. As the metal fine particles, at least one kind selected from the group consisting of Ag, Au, Pd, Ru, Pt, Ir, Re, Rh, Cu, and Ni is preferable. As the examples of a metal alloy composed of two or more metals, there can be given Au—Pd, Ru—Re, Au—Ag, Ag—Pd, and the like. Furthermore, in particular, as the above-mentioned metal oxide fine particles, there can be suitably employed composite metal oxide fine particles such as tin-doped indium oxide fine particles (hereinafter referred to as ITO fine particles) and antimony-doped tin oxide fine particles.

A conductive fine particle dispersion for use in the X-coating liquid of the present invention can be prepared by the following method. For example, in the case of a dispersion which contains composite metal oxide fine particles, such as ITO fine particles, an In salt and a Sn salt are hydrolyzed in alkali to coprecipitate hydroxides of Sn/In, and the coprecipitates are calcined, whereby the coprecipitates can be converted to an ITO powder. By mixing this ITO powder with a solvent, and dispersing the mixture in a conventionally known dispersing means such as sand mill, ball mill, homogenizer, or paint shaker, there can be obtained the dispersion. In the case of metal oxide fine particles, metal oxide fine particles and a solvent are mixed and dispersed in the above-mentioned dispersing means, whereby a dispersion can be obtained.

Furthermore, a metal fine particle dispersion can be prepared by adding to a metal salt solution a reducing agent such as ferrous sulfate, sodium boron hydride, or formaldehyde and subjecting metal fine particles to reduction and precipitation. At this moment, in order to improve the dispersibility, inorganic ions, an organic acid, a polymer and a surfactant, which are called protective colloid, may be incorporated. As these protective colloids, there can be given citric acid, formic acid, polyacrylic acid, polyvinyl alcohol, and celluloses. After the preparation thereof, the stability of the dispersion can be improved by removing unnecessary ions therefrom by ultrafiltration, ion exchange and other means.

In the above-mentioned dispersion, the metal fine particles preferably have a mean primary particle diameter of from 5 to 100 nm. When the mean primary particle diameter of the metal fine particles exceeds 100 nm, the scattering of visible light takes place in the film formed, so that the haze value of the film is increased and the visibility thereof is lowered. Furthermore, the dispersion uniformity and dispersion stability of the metal fine particles in the coating liquid are considerably impaired. The mean primary particle diameter of the metal fine particles is preferably from 5 to 30 nm, particularly preferably from 5to 20 nm, in view of the dispersion stability thereof in the coating liquid, and also in view of the conductivity of the film formed by coating the liquid.

For the same reasons as mentioned above, the mean primary particle diameter of the metal oxide fine particles is preferably from 5 to 100 nm, particularly preferably from 10 to 50 nm.

The concentration of the metal fine particles and the metal oxide fine particles in the X-coating liquid are preferably from 0.01 to 20 mass %, particularly preferably from 0.05 to 5 mass %, to the total mass of the coating liquid. When the concentration of the metal fine particles and the metal oxide fine particles exceed 20 mass %, the external appearance of the film formed is impaired, while when the concentration thereof is less than 0.01 mass %, the resistance of the film formed increases.

The conductive fine particle dispersion prepared by the above-mentioned method can be coated as it is. However, in order to trim the external appearance of the film to be formed, it is preferable to control the surface tension, viscosity and others of the liquid by appropriately diluting the dispersion with water and various conventional organic solvents.

For example, as the organic solvents, there can be preferably employed alcohols such as methanol, ethanol, n-propanol, isopropanol, n-butanol, isobutanol, sec-butanol and tert-butanol, polyhydric alcohols such as ethylene glycol, ethers such as ethyl cellosolve, methyl cellosolve, butyl cellosolve and propylene glycol methyl ether, ketones such as 2,4-pentanedione, diacetone alcohol, esters such as ethyl lactate and methyl lactate, or amides such as N-methyl-pyrrolidone.

To improve the coating suitability of the above-mentioned X-coating liquid, there can be added thereto, as an additive, SiO₂, in particular, a SiO₂ sol which can be obtained by hydrolyzing ethyl silicate or the like. The above-mentioned additives are preferable since by the addition of the additives to the coating liquid, the coating suitability of the coating liquid can be improved, and the color tone of the film to be formed can be controlled. These additives may be added in the form of fine particles, or in the form of a hydrolyzed product of a metal alkoxide, and in other forms, or in the form of a liquid dispersed in a dispersion mill such as an ultrasonic dispersion mill and a sand mill. Furthermore, in order to increase the wettability of the coating liquid to the substrate, various kinds of surfactants may be added to the above-mentioned X-coating liquid. As the surfactants, there can be given a sodium straight chain alkylbenzenesulfonate, an alkyl ether sulfuric ester and others. The coating liquid may further contain a coloring component such as titanium black, carbon black, and others in order to adjust the color tone and the transmittance of the film to be formed.

The XY film of the present invention is formed by coating onto a substrate the X-coating liquid containing the conductive fine particles, and then by coating the low-refraction film forming coating liquid thereon. The above-mentioned Y-coating liquid contains a silicon compound because the Y-coating liquid is capable of forming a low-refraction film having a lower refractive index and a higher hardness than the conductive film which is formed by coating the above-mentioned X-coating liquid.

As the silicon compound, various silicon compounds, which include silicon alkoxides, can be employed. As preferable materials, there can be given a liquid which contains therein a silicon alkoxide represented by Si(OR)_{y}.R′_{4-y} (where y is from 1 to 4, and R, R′ represent an alkyl group), or a liquid which contains a partially hydrolyzed product of the silicon alkoxide. As the above-mentioned silicon compound, for example, monomers or polymers of silicon ethoxide, silicon methoxide, silicon isopropoxide, and silicon butoxide can be preferably employed.

The above-mentioned Y-coating liquid can be prepared by dissolving a silicon alkoxide, which is a silicon compound, in a solvent such as alcohol, ester, ether and others. The Y-coating liquid can also be prepared by hydrolyzing a silicon alkoxide by adding hydrochloric acid, nitric acid, sulfuric acid, acetic acid, formic acid, maleic acid, hydrofluoric acid, or a water solution of ammonia to a silicon alkoxide solution prepared by dissolving a silicon alkoxide in the above-mentioned solvent. The above-mentioned silicon alkoxide is contained in the Y-coating solution, preferably in an amount of from 0.1 to 30 mass % in terms of a solid component concentration of SiO₂. Concentrations above 30 mass % are not preferable since the preservation stability of the liquid is impaired.

A MgF₂ sol may also be added to the above-mentioned Y-coating liquid for the purpose of lowering the refractive index. Furthermore, in order to enhance the strength of the film to be formed, there may be added as a binder an alkoxide of Zr, Sn, Al or others, or a partially hydrolyzed product thereof, thereby separating out a composite material of one or more of ZrO₂, SnO₂ and Al₂O₃, together with MgF₂ or SiO₂ at the same time. Furthermore, in order to improve the wettability of the Y-coating liquid to the substrate, a surfactant may be added to the coating liquid. As such a surfactant, there can be given a sodium straight chain alkylbenzenesulfonate, an alkyl ether sulfuric acid ester, and others.

The XY film of the present invention, as mentioned above, can be formed by coating the X-coating liquid and the Y-coating liquid onto the substrate. However, as a result of the present inventors' extensive studies, they have discovered that by containing a resistance-lowering material in the conductive film formed by the above manufacturing method, the conductivity of the conductive film is further increased and the lowering of the conductivity with time can be suppressed. A method of containing the resistance-lowering material in the conductive film has also been discovered as described later, in which the resistance-lowering material is contained in the Y-coating liquid which is to be coated onto the conductive film, whereby the resistance-lowering material is caused to penetrate from the formed low-refraction film into the conductive film, resulting in that the resistance-lowering-material is contained in the conductive film.

As the resistance-lowering material, there can be given, for example, a sulfur compound or titanium oxide. By coating a coating liquid which contains titanium oxide therein, a titanium oxide containing film can be formed.

A mechanism for increasing the conductivity of the conductive film by containing the sulfur compound in the conductive film is considered to be such that the oxidation of the surface of the fine particles at the time of heat treatment and also the oxidation of the surface of the fine particles with time when preserved in the atmosphere are suppressed by the adsorption of the sulfur compound on the surface of the conductive fine particles. In particular, with respect to metal oxide fine particles such as ITO fine particles, it is known that the oxygen defects at the surface of the fine particles constitute a generation source of carrier electrons, and when the oxygen defects are decreased by oxidation, the conductivity is considerably impaired. In the present invention, it is considered that the decrease of the oxygen defects is effectively suppressed by the adsorption of the above-mentioned sulfur compound, which results in that the conductivity of the film can be sharply improved, and at the same time, the impairing of the conductivity with time can also be suppressed.

There is no particular limitation with respect to the sulfur compound for use in the present invention as long as the sulfur compound remains in the above-mentioned conductive film when the coating liquid is dried or heated after the coating thereof. Specifically, there can be given sulfides such as sodium sulfide, potassium sulfide and ammonium sulfide, thiosulfates such as sodium thiosulfate, potassium thiosulfate and ammonium thiosulfate, thioacetic acid, thioacetates such as potassium thioacetate, sulfates such as sodium sulfate, potassium sulfate and ammonium sulfate, α-lipoic acid, α-lipoamide, thiodipropionic acid, thioglycollic acid, ethyl thioglycollate, 2-ethylhexyl thioglycollate, sodium thioglycollate, potassium thioglycollate, and thiourea. Of these compounds, one kind, or two or more kinds may be used.

As a method of containing the above-mentioned sulfur compound in the conductive film, for example, there can be given a method of directly containing the sulfur compound in the X-coating liquid and then coating the coating liquid onto a substrate, and a method of containing the sulfur compound in the Y-coating liquid, forming a conductive film, and then coating the Y-coating liquid. Furthermore, there can be employed any of a method of coating the sulfur compound as it is, or a coating liquid of the sulfur compound dissolved in an appropriate solvent, onto a substrate, and then from the side of the substrate coating in the order of sulfur compound coating liquid/X-coating liquid/Y-coating liquid, a method of coating in the order of X-coating liquid/sulfur compound coating liquid/Y-coating liquid or a method of coating in the order of X-coating liquid/Y-coating liquid/sulfur compound coating liquid.

Of these methods, in view of the stability of the conductive fine particles and the cost, a preferable form is the method of containing the sulfur compound in the Y-coating liquid, forming a conductive film, and then coating the Y-coating liquid. According to this method, the sulfur compound penetrates from the low-refraction film formed into the conductive film, and as a result, the sulfur compound can be contained in the conductive film.

The content of the sulfur compound in the above-mentioned Y-coating liquid is preferably from 0.01 to 1.5 mass % to the total amount of the Y-coating liquid. When the content is less than 0.01 mass %, the conductivity improving effect obtained by the addition of the sulfur compound is lowered, while when the content exceeds 1.5 mass %, the reflectivity of the film is increased, and the polymerization of a silicon alkoxide is hindered, so that the strength of the film is lowered. This is undesirable. The content is more preferably from 0.01 to 1.0 mass %, particularly preferably from 0.01 to 0.5 mass %, furthermore preferably from 0.01 to 0.2 mass %. The above-mentioned sulfur compound may be appropriately added in the course of the preparation of the above-mentioned Y-coating liquid.

The content of the sulfur compound in the conductive film formed is preferably from 0.1 to 10 mass %, when converted into the amount of sulfur in the conductive film, to the amount of the ITO fine particles in the conductive film. The content is particularly preferably from 0.1 to 7 mass %, furthermore preferably from 0.1 to 5 mass %. When the content is less than 0.1 mass %, the conductivity improvement effect obtained by the addition of the sulfur compound is lowered, while when the content exceeds 10 mass %, the reflectivity of the film is increased, and the polymerization of a silicon alkoxide is hindered, so that the strength of the film is lowered. This is undesirable.

Furthermore, the inventors of the present invention, as a result of extensive studies, have discovered that by irradiating the above-mentioned XY film with a light having larger energy than the band gap of the conductive fine particles which form the above-mentioned conductive film, the surface resistance value of the above-mentioned XY film can be lowered, and that the electromagnetic wave shielding performance can be improved.

A mechanism for the improvement on the conductivity of the above-mentioned XY film by the light irradiation thereto can be explained, for example, by a reduction in the contact resistance, caused by the desorption of oxygen which has been adsorbed on the conductive fine particles by the light irradiation, and also by an increase in the carrier electron density, caused by the photoexcitation of the conductive fine particles.

As a light source for use in the above-mentioned light irradiation, for example, when the conductive fine particles are ITO, a light source which can irradiate light having a larger energy than the band gap of ITO (the band gap of ITO depends on the concentration of the carrier, but corresponds to the light of from about 280 to 330 nm) is required, so that examples thereof are a low-pressure mercury lamp (center wavelength 254 nm) and sunlight. Further, the above-mentioned light irradiation is preferably carried out at an intensity of 0.01 μW/cm² or more. When the light intensity is less than 0.01 μW/cm², the resistance lowering effect by the photoexcitation is not sufficient. Although the resistance lowering effect manifests itself upon the light irradiation being carried out, light irradiation for the duration of 1 minute or more is preferable in order to obtain a sufficient effect.

The inventors of the present invention discovered that in the XY film comprising at least two films, namely a conductive film containing therein conductive fine particles, and a low-refraction film which is formed on the above-mentioned conductive film and has a lower refractive index than the conductive film, the surface resistance value of the XY film can be reduced and the electromagnetic wave shielding performance can be further improved by containing titanium oxide in the conductive film, and irradiating the XY film with a light having a larger energy than the band gap of the titanium oxide, in comparison with the case where the above-mentioned light irradiation is not carried out.

A mechanism for the improvement on the conductivity of the conductive film by containing therein titanium oxide can be explained as follows. By the titanium-oxide-containing conductive film being subjected to the light irradiation, not only is desorbed the adsorbed oxygen, but also is increased the carrier electron density of the conductive fine particles due to the movement of the electrons generated by the photoexcitation of the titanium oxide toward the conductive fine particles. Therefore, the light source for photoexciting titanium oxide is required to be such a light source that is capable of performing light irradiation with a light having energy greater than the band gap (about 400 nm) of titanium oxide. Examples of such a light source are a low-pressure mercury lamp (center wavelength 254 nm), a high-pressure mercury lamp (center wavelength 365 nm), sunlight, and indoor light (fluorescent lighting, electric lamp). The above-mentioned light irradiation is preferably carried out at an intensity of 0.01 μW/cm² or more. When the light intensity is less than 0.01 μW/cm², the lowering of the surface resistance value by the photoexcitation is not sufficient. Although the lowering of the surface resistance value is initiated upon the light irradiation being carried out, light irradiation for the duration of 1 minute or more is preferable in order to obtain a sufficient effect.

As a method of containing titanium oxide in the conductive film, there can be exemplified a method of containing a titanium oxide source in the X-coating liquid and then coating the coating liquid onto a substrate, or a method of containing a titanium oxide source in the Y-coating liquid, forming a conductive film, and then coating the Y-coating liquid. By containing the titanium oxide source in the Y-coating liquid, forming the conductive film, and then coating the above-mentioned Y-coating liquid, the titanium oxide source penetrates from the formed low-refraction film into the conductive film, so that titanium oxide can be contained in the conductive film.

As the titanium oxide source for containing titanium oxide in the conductive film, there is no particular limitation thereto as long as it is such a titanium oxide source that forms titanium oxide when a coating liquid which contains the titanium oxide source is coated on a substrate and then the coated coating liquid is dried or heated. As such a titanium oxide source, there can be exemplified not only titanium oxide which has been crystallized in advance, but also peroxotitanic acid, and a titanium alkoxide. Of these titanium oxide sources, the titanium oxide crystallized in advance is preferable since it exhibits sufficient crystallinity when subjected to low-temperature heating. The low-temperature heating means heating at temperatures from room temperature to about 200° C., although the temperature varies depending upon the solvent used.

The above-mentioned titanium oxide source is preferably such that the titanium oxide source is present in the form of titanium oxide fine particles in the coating liquid and that the titanium oxide fine particles have a mean primary particle diameter of from 5 to 100 nm. When the mean primary particle diameter exceeds 100 nm, scattering of visible light takes place at the film to be formed, and the haze value of the film is increased so that the visibility thereof is lowered, and the dispersion uniformity and dispersion stability of the titanium oxide fine particles are significantly impaired.

When the titanium oxide source is contained in the above-mentioned X coating liquid, the content of the titanium oxide source is preferably from 0.1 to 20 mass %, when converted into the amount of titanium oxide, to the conductive fine particles. When the added amount is less than 0.1 mass %, a sufficient electromagnetic wave shielding performance is not exhibited, while when the added amount exceeds 20 mass %, the stability of the coating liquid is impaired, and titanium oxide which is present in an amount more than necessary could cause conductivity hindrance on the contrary. This is undesirable. The added amount is more preferably from 0.1 to 10 mass %, particularly from 0.1 to 7 mass %, still more preferably from 0.1 to 5 mass %. Furthermore, the titanium oxide source may be added properly in the course of the preparation of the above-mentioned X coating liquid.

When the titanium oxide source is contained in the above-mentioned Y-coating liquid, the amount of the titanium oxide source to be added is preferably from 0.01 to 1.0 mass %, when converted to the amount of titanium oxide, to the total amount of the Y-coating liquid. When the added amount is less than 0.01 mass %, a sufficient electromagnetic wave shielding performance is not exhibited, while when the added amount exceeds 1.0 mass %, the reflectivity of the film is increased, and the polymerization of a silicon alkoxide which is a silicon compound is hindered, so that the strength of the film is lowered. This is undesirable. The amount to be added is more preferably from 0.01 to 0.5 mass %, particularly preferably from 0.01 to 0.3 mass %. The titanium oxide source may be appropriately added in the course of the preparation of the above-mentioned Y-coating liquid.

The content of titanium oxide in the formed conductive film is preferably from 0.1 to 20 mass % to the conductive fine particles. When the added amount is less than 0.1 mass %, a sufficient electromagnetic wave shielding performance is not exhibited, while when the added amount exceeds 20 mass %, the stability of the coating liquid is impaired, and titanium oxide which is present in an amount more than necessary could cause conductivity hindrance on the contrary. This is undesirable. The amount to be added is more preferably from 0.1 to 10 mass %, particularly preferably from 0.1 to 7 mass %, still more preferably from 0.1 to 5 mass %.

An XY film with a multi-layered structure can also be fabricated by providing another film between the above-mentioned substrate and the above-mentioned conductive film, between the conductive film and the above-mentioned low-refraction film, or on the above-mentioned low-refraction film (the opposite side to the substrate). As the structure of the multi-layered low-refraction film having an anti-reflection performance, the following typical examples are known, a two-layered low-refraction film formed of a high-refraction film—a low-refraction film layered from the side of the substrate, with the respective optical thicknesses of λ/2 -λ/4, or with the respective optical thicknesses of λ/4 -λ/4, wherein λ is a wavelength of the light to be anti-reflected, a three-layered low-refraction film formed of a medium-refraction film—a high-refraction film—a low-refraction film layered from the side of the substrate, with the respective optical thicknesses of λ/4 -λ/2 -λ/4, and a four-layered low-refraction film formed of a low-refraction-index film—a medium-refraction-index film—a high-refraction-index film—a low-refraction-index film layered from the side of the substrate, with the respective optical thicknesses of λ/2 -λ/2 -λ/2 -λ/4.

The X-coating liquid of the present invention can be used for the formation of the medium-refraction film to the high-refraction film of the film of the above-mentioned multi-layered structure films. The Y-coating liquid can be used for the formation of the low-refraction film of the above-mentioned multi-layered structure films. As the medium-refraction film to the high-refraction film, a colored film may be used which contains a coloring component such as carbon black, titanium black, in order to adjust the color of the film to be formed. Of the examples of the above-mentioned multi-layered structure films, preferable is an XYZ film which is composed of at least three films, namely a colored film containing therein a coloring component, a conductive film containing therein conductive fine particles, which is formed on the colored film, and a low-refraction film with a lower refractive index than the conductive film, which is formed on the conductive film, because it is expected that SiO₂ will penetrate from the formed low-refraction film into the conductive film, resulting in that the conductivity will be increased by the formation of conductive paths due to the shrinkage of the film at the time of calcination. Furthermore, by containing titanium oxide in the conductive film, and irradiating the XYZ film with a light having a greater energy than the band gap of titanium oxide, the surface resistance value of the XYZ film can be lowered and the electromagnetic wave shielding performance can be further improved in comparison with the case where the above-mentioned light irradiation is not carried out.

Furthermore, the XYZ film can be formed by coating a colored film forming coating liquid which contains a coloring component (hereinafter referred to as Z-coating liquid as well) onto a substrate, then by coating an X-coating liquid which contains conductive fine particles, and then coating a Y-coating liquid which contains a sulfur compound. When coating the Z-coating liquid onto a cathode ray tube panel, the colored film preferably has a neutral color tone (that is, the colored film has no particular absorption in the wavelength region of visible light) in order to improve contrast. From this point of view, as the coloring component to be contained in the colored film, for example, carbon black and titanium black are preferable.

The above-mentioned Z-coating liquid can be obtained by mixing the above-mentioned coloring component with a liquid solvent, making the mixture acidic appropriately in order to improve the dipersibility thereof, obtaining a dispersion by use of a conventional dispersing means such as a sand mill, and then appropriately diluting the dispersion with a solvent. The concentration of the coloring component is preferably from 0.5 to 2.0 mass %.

Furthermore, for the purposes of moderating the differences in transmittance within the panel surface caused by the thickness of the glass, reducing the transmittance within the panel face in its entirety, and improving the contrast at the time of image displaying, the film thickness of the colored film can be adjusted, that is, the thickness of the colored film in the portion where the substrate is thick can be reduced. On the contrary, the thickness of the colored film in the portion where the substrate is thin can be increased. Furthermore, the colored film in the portion where the substrate is thick can be made light in color tone, while the colored film in the portion where the substrate is thin can be made deep in color tone.

The above-mentioned X-coating liquid, Y-coating liquid and Z-coating liquid can be appropriately coated onto the substrate by a coating method, such as a spin coating method, a dip coating method and a spray coating method. An anti-glare effect may be imparted to the film to be formed by forming ruggedness on the surface thereof by use of the spray coating method. Furthermore, a hard coat film such as a silica coat film may be provided thereon.

Furthermore, a non-glare coat film made of a silica coated film having ruggedness on the surface thereof may be provided by forming a conductive film of the present invention by the spin coating method or the spray coating method, and then performing spray coating thereon of a solution containing a silicon alkoxide.

After coating the X-coating liquid, the Y-coating liquid, and the Z-coating liquid onto the substrate, a heat treatment is preferably conducted in order to form the XY film or the XYZ film. When a medium- to high-boiling-point solvent with a boiling point of from 100 to 250° C. is used as the solvent for the coating liquids, the temperature for the heat treatment is preferably 100° C. or more in order to prevent the solvent from remaining in the films. On the other hand, when a low-boiling-point solvent with a boiling point of 100° C. or less is used as the solvent for the coating liquids, the films can be formed by drying at room temperature or by heat treatment. The temperature for the heat treatment is determined in accordance with the softening point of glass, plastics or the like, to be used as the substrate. Preferable temperatures for the heat treatment are from 100 to 500° C.

The coating amounts (film thicknesses) of the X-coating liquid, the Y-coating liquid and the Z-coating liquid of the present invention vary depending upon the kind of the substrate to be coated, and the objectives of the use of the substrate to be coated. The coating amount of the X-coating liquid is preferably in the range of from about 5 to 200 nm in terms of the thickness of the cured film (the film when completely cured)of the conductive film. When the thickness is less than 5 nm, the conductivity of the film is lowered, and the low reflecting properties are also lowered when the two-layered film or the multi-layered film is formed, so that such thickness is not preferable, and even when the thickness exceeds 200 nm, the low reflecting properties are lowered, so that such thickness is not preferable, either. The coating amount of the Y-coating liquid is preferably in the range of from about 5 to 150 nm in terms of the thickness of the cured film of the low-refraction film. When the thickness is less than 5 nm, the strength of the film is lowered, so that such thickness is not preferable, while when the thickness exceeds 150 nm, the low reflecting properties at the time of the formation thereof are lowered, so that such thickness is not preferable. The coating amount of the Z-coating liquid is preferably in the range of from about 5 to 200 nm, particularly preferable in the range of from 10 to 60 nm, in terms of the thickness of the cured film of the colored film. When the thickness is less than 5 nm, the coloring becomes insufficient, while when the thickness is more than 200 nm, the transmittance is excessively lowered, so that such thickness is not preferable.

The XY film or the XYZ film of the present invention contains a resistance-lowering material, and therefore has a low surface resistance value and excellent electromagnetic wave shielding performance. The surface resistance value of the XY film or the XYZ film is preferably 3.0×10³ Ω/□ or less, particularly more preferably 2.5×10³ Ω/□ or less.

As substrates on which the XY film or the XYZ film of the present invention is to be formed, there can be given various kinds of glasses and plastic substrates (including filters formed on the substrate), such as a cathode ray tube panels, glass plates for copying machines, panels for calculators, glasses for clean rooms, face boards of display apparatus for LCD and PDP. As the display apparatus in the present invention, there can be given cathode ray tube, copying machine, calculator, LCD, PDP, and others.

### EXAMPLES

With reference to Examples (Examples 1 to 9, 13 to 26, 28 to 31) and Comparative Examples (Examples 10 to 12, 27), the present invention will be explained more specifically. However, the present invention will not be limited to these Examples. In the Examples and Comparative Examples shown below, the mean primary particle diameter of the particles in the sols obtained was measured by use of TEM (transmission electron microscope, H9000 made by Hitachi, Ltd.). The obtained films were evaluated by the following evaluation method.

1) Surface resistance value: The surface resistance value of a film formed on a substrate was measured by Loresta resistivity meter (made by Mitsubishi Petrochemical Co., Ltd.).

2) Reflectance: The luminous reflectance of a film formed on a substrate was measured at from 400 to 700 nm by use of self-recording spectro photometer U-3500 (made by Hitachi, Ltd.).

3) Abrasion resistance: The surface of a film was rubbed 50 times reciprocatingly with a rubber eraser (50-50 made by Lion Corp.) under the application of a load of 1 kg, and the scratches formed on the surface of the film were visually inspected. Evaluation criteria were: O: not scratched at all, Δ: slightly scratched, X: the film was partly peeled away.

4) Oxidation resistance: A substrate with a film formed thereon was preserved in a high-temperature air at 80° C. (the humidity of the high-temperature air was the same as room humidity) for 200 hours, and then taken out to measure the surface resistance value thereof in the same manner as in 1).

5) Film thickness: A cross section of a substrate with a film formed thereon was observed and measured by use of SEM (scanning electron microscope, JSM6340F made by JEOL, Ltd.).

6) Transmittance of film: The transmittance of a substrate with a film formed thereon was measured at 550 nm by use of self-recording spectro photometer U-3500 (made by Hitachi, Ltd.). From the thus measured transmittance was deducted the transmittance of the substrate measured thereafter, whereby only the transmittance of the film was measured.

7) Content of sulfur: By use of Marcus type high frequency glow discharge light emitting surface analyzer JY-500RF (made by Horiba, Ltd.), the intensity of each element of S, In, Sn, O and Si was measured in the direction of the depth of a conductive film, and integrated with respect to the depth of the film, and then a value converted into the molar ratio of each element was obtained. From the molar ratio of each element, the content of sulfur was determined by calculation, using the formula of the content of sulfur=the mass of sulfur in the conductive film/the mass of ITO (the mass ratio of SnO₂ being 17.5 mass %) in the conductive film.

8) Content of titanium oxide: By use of Marcus type high frequency glow discharge light emitting surface analyzer JY-500RF (made by Horiba, Ltd.), the intensity of each element of Ti, In, Sn, O and Si was measured in the direction of the depth of a conductive film, and integrated with respect to the depth of the film, and then a value converted into the molar ratio of each element was obtained. From the molar ratio of each element, the content of titanium oxide was determined by calculation, using the formula of the content of titanium oxide=the mass of titanium oxide in the conductive film/the mass of ITO (the mass ratio of SnO₂ being 17.5 mass %) in the conductive film.

(1) In the case where the resistance-lowering material is a sulfur compound

(Preparation of ITO Fine Particle Dispersion)

An indium nitrate aqueous solution of 79.9 g of indium nitrate dissolved in 686 g of water, and a potassium stannate aqueous solution of 12.7 g of potassium stannate dissolved in 400 g of a 10% potassium hydroxide aqueous solution were prepared.

The above-mentioned indium nitrate aqueous solution and potassium stannate aqueous solution were added, with stirring, to 1000 g of water which was heated at 50° C., and the indium nitrate and potassium stannate in the aqueous solution were hydrolyzed, while maintaining pH of the mixed solution at 11. Fine particles thus formed were filtered off, washed, dried, calcined in nitrogen at 300° C. for 3 hours, and further calcined in an atmosphere of nitrogen at 500° C. for 6 hours, whereby ITO fine particles (A) (the mass ratio of SnO₂ being 17.5 mass %) were obtained.

100 g of the fine particles (A) was dispersed in 40 g of acetylacetone, and then 360 g of ethanol was added thereto. This dispersion was placed in a sand mill, and the fine particles (A) in the dispersion were pulverized for 5 hours, whereby Liquid A with an ITO solid component concentration of 20 mass % was obtained.

The mean particle diameter of the fine particles in the Liquid A was 40 nm. The thus obtained Liquid A was stable over a period of more than 6 months without agglomeration and sedimentation of the fine particles.

(Preparation of X-Coating Liquids)

The above-mentioned Liquid A was diluted with a mixed solvent (Liquid B) of methanol/ethylene glycol monoisopropyl ether/diacetone alcohol=100/25/5 (mass ratio) in such a manner that the ITO solid component concentration thereof became 3.5 mass %, whereby an X-coating liquid (Liquid C) was obtained.

The Liquid B and a carbon black dispersion (solid component 10 mass %) were mixed in such a manner that the solid component ratio thereof became 2:100, and the mixture was diluted with a mixed solvent of methanol/ethylene glycol monoisopropyl ether/diacetone alcohol=100/25/5 (mass ratio) in such a manner that the solid component mass thereof became 3.5 mass %, whereby an X-coating liquid (Liquid C2) was obtained. The thus obtained Liquid C and Liquid C2 were stable over a period of more than 2 months without agglomeration and sedimentation of the fine particles.

(Preparation of Y-Coating Liquid)

50 g of ethyl silicate was dissolved in 200 g of methanol. To this solution was added dropwise, with stirring, a mixed solution of 1.5 g of concentrated nitric acid and 33 g of pure water, and the mixture was stirred at room temperature for 2 hours, whereby a liquid (Liquid D) with a SiO₂ concentration of 4.9 mass % was obtained.

The Liquid D was diluted with a mixed solvent of isopropyl alcohol/ethylene glycol monoisopropyl ether/acetyl acetone/dimethyl formamide=100/24/8/8 (mass ratio) in such a manner that the solid component concentration of SiO₂ thereof became 1.3 mass % (Liquid E) The thus obtained Liquid E was stable over a period of more than 6 months without agglomeration and sedimentation of fine particles.

To 99.55 g of the above-mentioned Liquid E was added 0.05 g of α-lipoic acid (made by Wako Pure Chemical Industries, Ltd.), whereby a Y-coating liquid (Liquid E1) was obtained. The thus obtained Liquid E, and Liquids E1 to E7 which will be explained later, were stable over a period of more than 6 months without agglomeration and sedimentation of fine particles.

(Preparation of Z-Coating Liquid)

5 g of titanium black (Model No. 13M: made by Mitsubishi Material Corporation) and 50 g of an acidic aqueous solution of nitric acid with the pH thereof adjusted to 3 were mixed and pulverized in a sand mill for 2 hours, whereby a Liquid F with a titanium black solid component concentration of 9 mass % was obtained. The mean particle diameter of the fine particles in this Liquid F was 80 nm. The thus obtained Liquid F was stable over a period of more than 2 months without agglomeration and sedimentation of the fine particles.

The above-mentioned Liquid F was diluted with a mixed solvent of methanol/ethylene glycol monoisopropyl ether/diacetone alcohol=100/25/5 (mass ratio) in such a manner that the titanium black solid component concentration became 0.9 mass %, whereby a Z-coating liquid (Liquid G) was obtained.

### Example 1

The surface of a panel of a 14-inch cathode ray tube was washed with ethanol and water. The panel surface was then abraded by use of fine particles of CeO₂, and washed. With the panel surface heated at 45° C., 20 g of the Liquid C was coated onto the panel surface of the 14-inch cathode ray tube by the spin coating method under the conditions of 150 rpm for 90. seconds. Thereafter, 20 g of the Liquid E1 was coated by the spin coating method under the conditions of 120 rpm for 90 seconds, followed by heating at 210° C. for 30 minutes, whereby an XY film was obtained. The film thickness of the cured film of the conductive film which formed the XY film was 100 nm, and the film thickness of the cured film of the low-reflection film was 100 nm.

### Example 2

To 99.95 g of the above-mentioned Liquid D was added 0.05 g of α-lipoamide (made by Tokyo Kasei Co., Ltd.), whereby a Y-coating liquid (Liquid E2) was obtained.

An XY film was obtained by carrying out the same process as in Example 1 except that the Liquid E2 was employed instead of the Liquid E1 in Example 1.

### Example 3

To 99.95 g of the above-mentioned Liquid D was added 0.05 g of thiodipropionic acid (made by Junsei Chemical Co., Ltd.), whereby a Y-coating liquid (Liquid E3) was obtained.

An XY film was obtained by carrying out the same process as in Example 1 except that the Liquid E3 was employed instead of the Liquid E1 in Example 1.

### Example 4

To 99.95 g of the above-mentioned Liquid D was added 0.05 g of sodium thiosulfate (made by Junsei Chemical Co., Ltd.), whereby a Y-coating liquid (Liquid E4) was obtained.

An XY film was obtained by carrying out the same process as in Example 1 except that the Liquid E4 was employed instead of the Liquid E1 in Example 1.

### Example 5

To 99.95 g of the above-mentioned Liquid D was added 0.05 g of thiourea (made by Junsei Chemical Co., Ltd.), whereby a Y-coating liquid (Liquid E5) was obtained.

An XY film was obtained by carrying out the same process as in Example 1 except that the Liquid E5 was employed instead of the Liquid E1 in Example 1.

### Example 6

To 99.95 g of the above-mentioned Liquid D was added 0.05 g of sodium thioglycollate (made by Junsei Chemical Co., Ltd.), whereby a Y-coating liquid (Liquid E6) was obtained.

An XY film was obtained by carrying out the same process as in Example 1 except that the Liquid E6 was employed instead of the Liquid E1 in Example 1.

### Example 7

To 99.9 g of the above-mentioned Liquid D was added 0.1 g of α-lipoic acid (made by Wako Pure Chemical Industries, Ltd.), whereby a Y-coating liquid (Liquid E7) was obtained.

An XY film was obtained by carrying out the same process as in Example 1 except that the Liquid E7 was employed instead of the Liquid E1 in Example 1.

### Example 8

An XYZ film was obtained by carrying out the same process as in Example 1 except that the Liquid C2 was employed instead of the Liquid C in Example 1.

### Example 9

The surface of a panel of a 14-inch cathode ray tube was washed with ethanol and water. The panel surface was then abraded by use of fine particles of CeO₂, and washed. With the panel surface heated at 45° C., 25 g of the Liquid G was coated onto the panel surface of the 14-inch cathode ray tube by the spin coating method under the conditions of 150 rpm for 90 seconds, whereby a colored film was formed. Thereafter, 20 g of the Liquid C was coated onto the colored film by the spin coating method under the conditions of 150 rpm for 90 seconds, and 20 g of the Liquid E1 was further coated by the spin coating method under the conditions of 120 rpm for 90 seconds, followed by heating at 210° C. for 30 minutes, whereby an XYZ film was obtained. The film thickness of the cured film of the colored film which formed the XYZ film was 40 nm. The film thickness of the cured film of the conductive film was 100 nm, and the film thickness of the cured film of the low-reflectance film was 100 nm.

### Example 10

An XY film was obtained by carrying out the same process as in Example 1 except that the Liquid E (which did not contain a sulfur compound) was employed instead of the Liquid E1 in Example 1.

### Example 11

To 98.0 g of the above-mentioned Liquid E was added 2.0 g of α-lipoic acid (made by Wako Pure Chemical Industries, Ltd.), whereby a Y-coating liquid (Liquid E8) was obtained.

An XY film was obtained by carrying out the same process as in Example 1 except that Liquid E8 was employed instead of Liquid E1 in Example 1.

### Example 12

An XYZ film was obtained by carrying out the same process as in Example 9 except that the Liquid E (which did not contain a sulfur compound) was employed instead of the Liquid E1 in Example 8.

(Results of Evaluation)

The sulfur content, surface resistance value, reflectance, abrasion resistance, oxidation resistance, and transmittance of the XY films and the XYZ films obtained in Examples 1 to 12 were measured, and the results are shown in Table 1. In Table 1, 3.0E3 denotes 3.0×10³, and the same applies to the other values.

TABLE 1

| | | | | Surface | | | | |
|---|---|---|---|---|---|---|---|---|
| | Kind of | Added | Content | resistance | | | Oxidation | |
| | sulfur | amount | of | value | Reflectance | Abrasion | resistance | Transmittance |
| | compound | (%) | sulfur | (Ω/□) | (%) | resistance | (Ω/□) | (%) |
| Example 1 | α-lipoic | 0.05 | 0.33 | 1.5E3 | 1.9 | ∘ | 2.7E3 | 100 |
| | acid | | | | | | | |
| Example 2 | α-lipoamide | 0.05 | 0.33 | 1.4E3 | 1.8 | ∘ | 2.6E3 | 100 |
| Example 3 | Thiodipropionic | 0.05 | 0.19 | 1.6E3 | 2.0 | ∘ | 3.0E3 | 100 |
| | acid | | | | | | | |
| Example 4 | sodium | 0.05 | 0.44 | 1.5E3 | 1.8 | ∘ | 3.0E3 | 100 |
| | thiosulfate | | | | | | | |
| Example 5 | thiourea | 0.05 | 0.45 | 1.5E3 | 1.9 | ∘ | 3.0E3 | 100 |
| Example 6 | sodium | 0.05 | 0.30 | 1.9E3 | 1.9 | ∘ | 3.5E3 | 100 |
| | thioglycollate | | | | | | | |
| Example 7 | α-lipoic | 0.1 | 0.66 | 1.3E3 | 2.0 | ∘ | 2.5E3 | 100 |
| | acid | | | | | | | |
| Example 8 | α-lipoic | 0.05 | 0.33 | 2.5E3 | 1.4 | ∘ | 9.0E3 | 80 |
| | acid | | | | | | | |
| Example 9 | α-lipoic | 0.05 | 0.33 | 1.5E3 | 1.4 | ∘ | 2.8E3 | 80 |
| | acid | | | | | | | |
| Example 10 | — | 0.0 | 0 | 3.0E3 | 1.5 | ∘ | 7.1E3 | 100 |
| Example 11 | α-lipoic | 2.0 | 13.2 | 6.8E3 | 4.5 | Δ | 1.2E4 | 100 |
| | acid | | | | | | | |
| Example 12 | — | 0.0 | 0 | 9.2E3 | 1.4 | ∘ | 1.5E3 | 80 |

(2) In the Case where the Resistance-Lowering Material is Titanium Oxide

(Preparation of X-Coating Liquid)

An indium nitrate aqueous solution of 79.9 g of indium nitrate dissolved in 686 g of water, and a potassium stannate aqueous solution of 12.7 g of potassium stannate dissolved in 400 g of a 10 mass % potassium hydroxide aqueous solution were prepared.

The above-mentioned indium nitrate aqueous solution and potassium stannate aqueous solution were added, with stirring, to 1000 g of water which was heated at 50° C., and the indium nitrate and potassium stannate in the aqueous solution were hydrolyzed, while maintaining the pH of the mixed solution at 11. Fine particles of ITO formed were filtered off, washed, dried, calcined in nitrogen at 300° C. for 3 hours, and further calcined in an atmosphere of nitrogen at 500° C. for 6 hours, whereby ITO fine particles (the mass ratio of SnO₂ being 17.5 mass %) were obtained.

100 g of the ITO fine particles was dispersed in 40 g of acetylacetone, and then 360 g of ethanol was added thereto, whereby a conductive film forming dispersion was prepared. This conductive film forming dispersion was placed in a sand mill, and pulverized for 5 hours, whereby a Liquid J with an ITO solid component concentration of 20 mass % was obtained.

The mean particle diameter of the ITO fine particles in the Liquid J was 40 nm. The Liquid J was stable over a period of more than 6 months without agglomeration and sedimentation of the fine particles.

The Liquid J was diluted with a mixed solvent (Liquid K) of methanol/ethylene glycol monoisopropyl ether/diacetone alcohol=100:25:5 (mass ratio) in such a manner that the ITO solid component concentration thereof became 3.5 mass %, whereby an X-coating liquid (Liquid L) was obtained.

The Liquid J and a titanium oxide fine particle dispersion (prepared by diluting a crystallized titanium oxide powder (made by Ishihara Sangyo Kaisha, Ltd.: ST-K01) with methanol so as to make the solid component thereof 2 mass %) were mixed in such a manner that the content of titanium oxide was 2.8 wt.% to the ITO fine particles, and the mixture was diluted with the Liquid K in such a manner that the solid component concentration became 3.6 mass %, whereby an X-coating liquid (Liquid L1) was obtained.

The Liquid J and a carbon black dispersion (solid component 10 mass %) were mixed in such a manner that the solid component ratio thereof became 2:100, and the mixture was diluted with the Liquid K in such a manner that the solid component mass thereof became 3.5 mass %, whereby an X-coating liquid (Liquid L2) was obtained. The thus obtained Liquids L, L1 and L2 were stable over a period of more than 6 months without agglomeration and sedimentation of the fine particles.

(Preparation of Y-Coating Liquid)

50 g of ethyl silicate was dissolved in 200 g of methanol. To this solution was added dropwise, with stirring, a mixed solution of 1.5 g of concentrated nitric acid and 33 g of pure water, and the mixture was stirred at room temperature for 2 hours, whereby a liquid (Liquid M) with a SiO₂ concentration of 4.9 mass % was obtained.

The Liquid M was diluted with a mixed solvent of isopropyl alcohol/ethylene glycol monoisopropyl ether/acetyl acetone/dimethyl formamide=100/24/8/8 (mass ratio) in such a manner that the SiO₂ solid component concentration thereof became 1.3 mass % (Liquid N). The thus obtained Liquid N was stable over a period of more than 6 months without agglomeration and sedimentation of fine particles.

To 92.3 g of the Liquid N was added a titanium oxide fine particle dispersion (prepared by diluting a crystallized titanium oxide powder (made by Ishihara Sangyo Kaisha, Ltd.: ST-K01) with methanol so as to make the solid component thereof 1.3 mass %) was diluted with methanol so as to make the solid component thereof 1.3 mass %) in such a manner that the added amount of titanium oxide was 0.1 wt.% to the Liquid N, and the mixture was stirred, whereby a Y-coating liquid (Liquid N1) with a solid component of 1.3 mass % was obtained. The thus obtained Liquid N1 was stable over a period of 6 months without agglomeration and sedimentation of the fine particles.

(Preparation of Z-Coating Liquid)

5 g of titanium black (made by Mitsubishi Material Corporation: Model No. 13M) and 50 g of an acidic aqueous solution of nitric acid with the pH thereof adjusted to 3 were mixed and pulverized in a sand mill for 2 hours, whereby a colored film forming dispersion (Liquid P) with a titanium black solid component concentration of 9 mass % was obtained. The mean particle diameter of the fine particles in the Liquid P was 80 nm. The thus obtained Liquid P was stable over a period of more than 2 months without agglomeration and sedimentation of the fine particles.

The Liquid P was diluted with a mixed solvent of methanol/ethylene glycol monoisopropyl ether/diacetone alcohol=100/25/5 (mass ratio) in such a manner that the titanium black solid component concentration thereof became 0.9 mass %, whereby a Z-coating liquid (Liquid Q) was obtained.

### Example 13

The surface of a panel of a 14-inch cathode ray tube was washed with ethanol and water. The panel surface was then abraded by use of fine particles of CeO₂, and washed. With the panel surface heated at 45° C., 20 g of the Liquid L1 was coated onto the panel surface of the 14-inch cathode ray tube by the spin coating method under the conditions of 150 rpm for 90 seconds. Thereafter, 20 g of the Liquid N was coated by the spin coating method under the conditions of 120 rpm for 90 seconds, followed by heating the panel at 210° C. for 30 minutes, whereby an XY film was obtained. The film thickness of the conductive film which formed the XY film was 200 nm, and the film thickness of the low-refraction film was 100 nm. The above-mentioned XY film was irradiated with a low-pressure mercury lamp (main wavelength 254 nm) at an intensity of 0.2 mW/cm² for 10 minutes, whereby an XY film was obtained.

### Example 14

An XY film was obtained in the same manner as in Example 13 except that the irradiation was carried out using a high-pressure mercury lamp (main wavelength 365 nm) instead of the low-pressure mercury lamp at an intensity of 0.2 mW/cm² for 10 minutes.

### Example 15

An XY film was obtained in the same manner as in Example 13 except that the irradiation was carried out using a desk light (fluorescent lighting, white light) instead of the low-pressure mercury lamp at an intensity of 5 μW/cm² for 60 minutes.

### Example 16

An XY film was obtained in the same manner as in Example 13 except that the irradiation was carried out using an indoor light (fluorescent lighting, white light) instead of the low-pressure mercury lamp at an intensity of 0.5 μW/cm² for 300 minutes.

### Example 17

An XY film was obtained in the same manner as in Example 13 except that the low-pressure mercury lamp was not used (no irradiation was carried out).

### Example 18

An XY film was obtained in the same process as in Example 13 except that the Liquid L was used instead of the Liquid L1, and that the Liquid N1 was used instead of the Liquid N.

### Example 19

An XY film was obtained in the same manner as in Example 18 except that the irradiation was carried out using a high-pressure mercury lamp (main wavelength 365 nm) instead of the low-pressure mercury lamp at an intensity of 0.2 mW/cm² for 10 minutes.

### Example 20

An XY film was obtained in the same manner as in Example 18 except that the irradiation was carried out using a desk light (fluorescent lighting, white light) instead of the low-pressure mercury lamp at an intensity of 5 μW/cm² for 60 minutes.

### Example 21

An XY film was obtained in the same manner as in Example 18 except that the irradiation was carried out using an indoor light (fluorescent lighting, white light) instead of the low-pressure mercury lamp at an intensity of 0.5 μW/cm² for 300 minutes.

### Example 22

An XY film was obtained in the same manner as in Example 18 except that the low-pressure mercury lamp was not used (no irradiation was carried out).

### Example 23

An XY film was obtained in the same process as in Example 18 except that the Liquid N was used instead of the Liquid N1.

### Example 24

An XY film was obtained in the same manner as in Example 23 except that the irradiation was carried out using a high-pressure mercury lamp (main wavelength 365 nm) instead of the low-pressure mercury lamp at an intensity of 0.2 mW/cm² for 10 minutes.

### Example 25

An XY film was obtained in the same manner as in Example 23 except that the irradiation was carried out using a desk light (fluorescent lighting, white light) instead of the low-pressure mercury lamp at an intensity of 5 μW/cm² for 60 minutes.

### Example 26

An XY film was obtained in the same manner as in Example 23 except that the irradiation was carried out using an indoor light (fluorescent lighting, white light) instead of the low-pressure mercury lamp at an intensity of 0.5 μW/cm² for 300 minutes.

### Example 27

### Comparative Example

An XY film was obtained in the same manner as in Example 23 except that the low-pressure mercury lamp was not used (no irradiation was carried out).

### Example 28

The surface of a panel of a 14-inch cathode ray tube was washed with ethanol and water. The panel surface was then abraded by use of fine particles of CeO₂, and washed. With the panel surface heated at 45° C., 20 g of the Liquid L2 was coated onto the panel surface of the 14-inch cathode ray tube by the spin coating method under the conditions of 150 rpm for 90 seconds. Thereafter, 20 g of the Liquid N1 was coated by the spin coating method under the conditions of 120 rpm for 90 seconds, followed by heating the panel at 210° C. for 30 minutes, whereby an XY film was obtained. The film thickness of the conductive film which formed the XY film was 200 nm, and the film thickness of the low-refraction film was 100 nm. The above-mentioned XY film was irradiated with a desk light (white light) at an intensity of 5 μW/cm² for 60 minutes, whereby the XY film was obtained.

### Example 29

An XY film was obtained in the same manner as in Example 28 except that the Liquid N1 was replaced by the Liquid N (that is, the Y-coating liquid free of titanium oxide was employed).

### Example 30

The surface of a panel of a 14-inch cathode ray tube was washed with ethanol and water. The panel surface was then abraded by use of fine particles of CeO₂, and washed. With the panel surface heated at 45° C., 25 g of the Liquid Q was coated onto the panel surface of the 14-inch cathode ray tube by the spin coating method under the conditions of 150 rpm for 90 seconds, whereby a colored film was formed. Thereafter, 20 g of the Liquid L was coated onto the colored film by the spin coating method under the conditions of 150 rpm for 90 seconds. Furthermore, 20 g of the Liquid N1 was coated thereon by the spin coating method under the conditions of 120 rpm for 90 seconds, followed by heating at 210° C. for 30 minutes, whereby an XYZ film was obtained. The film thickness of the cured film of the colored film which formed the XYZ film was 40 nm, the film thickness of the cured film of the conductive film was 200 nm, and the film thickness of the cured film of the low-reflectance film was 100 nm. The above-mentioned XY film was irradiated with a desk light (white light) at an intensity of 5 μW/cm² for 60 minutes, whereby an XY film was obtained.

### Example 31

An XYZ film was obtained in the same manner as in Example 30 except that the Liquid N1 was replaced by the Liquid N (that is, the Y-coating liquid free of titanium oxide was employed).

(Results of Evaluation)

The surface resistance value, luminous reflectance, abrasion resistance, and transmittance of the XY films and the XYZ films obtained in Examples 13 to 31 were measured, and the results are shown in Table 2 and Table 3. In Table 2 and Table 3, 3.0E3 denotes 3.0×10³, and the same applies to the other values.

TABLE 2

| | Added amount of | | | | | | | | |
|---|---|---|---|---|---|---|---|---|---|
| | titanium oxide | | | | | | | | |
| | source (mass %) | | | | | | | | |
| | | In low- | | | | | | | |
| | In conductive | refraction | Content | | | | | | |
| | film | film | of | | | Surface | | | |
| | forming | forming | titanium | Irradiation | | resistance | | | |
| | coating | coating | oxide | light | Conditions | value | Reflectance | Abrasion | Transmittance |
| | liquid | liquid | (%) | source | for irradiation | (Ω/□) | (%) | resistance | (%) |
| Example 13 | 0.1 | — | 2.8 | Low- | 10 min | 1.0E3 | 1.8 | ∘ | 100 |
| | | | | pressure | | | | | |
| | | | | mercury | | | | | |
| | | | | lamp | | | | | |
| Example 14 | 0.1 | — | 2.8 | High- | 10 min | 1.3E3 | 1.8 | ∘ | 100 |
| | | | | pressure | | | | | |
| | | | | mercury | | | | | |
| | | | | lamp | | | | | |
| Example 15 | 0.1 | — | 2.8 | Desk | 60 min | 2.1E3 | 1.8 | ∘ | 100 |
| | | | | light | | | | | |
| Example 16 | 0.1 | — | 2.8 | Indoor | 300 min | 2.4E3 | 1.8 | ∘ | 100 |
| | | | | light | | | | | |
| Example 17 | 0.1 | — | 2.8 | None | — | 3.5E3 | 1.5 | ∘ | 100 |
| Example 18 | — | 0.1 | 3.3 | Low- | 10 min | 7.5E2 | 1.5 | ∘ | 100 |
| | | | | pressure | | | | | |
| | | | | mercury | | | | | |
| | | | | lamp | | | | | |
| Example 19 | — | 0.1 | 3.3 | High- | 10 min | 1.2E3 | 1.5 | ∘ | 100 |
| | | | | pressure | | | | | |
| | | | | mercury | | | | | |
| | | | | lamp | | | | | |
| Example 20 | — | 0.1 | 3.3 | Desk | 60 min | 1.4E3 | 1.5 | ∘ | 100 |
| | | | | light | | | | | |
| Example 21 | — | 0.1 | 3.3 | Indoor | 300 min | 1.9E3 | 1.5 | ∘ | 100 |
| | | | | light | | | | | |
| Example 22 | — | 0.1 | 3.3 | None | — | 2.5E3 | 2.0 | ∘ | 100 |

TABLE 3

| | Added amount of | | | | | | | | |
|---|---|---|---|---|---|---|---|---|---|
| | titanium oxide | | | | | | | | |
| | source (mass %) | | | | | | | | |
| | In | In low- | | | | | | | |
| | conductive | refraction | Content | | | | | | |
| | film | film | of | | | Surface | | | |
| | forming | forming | titanium | Irradiation | Conditions | resistance | | | |
| | coating | coating | oxide | light | for | value | Reflectance | Abrasion | Transmittance |
| | liquid | liquid | (%) | source | irradiation | (Ω/□) | (%) | resistance | (%) |
| Example 23 | — | — | 0 | Low- | 10 min | 1.4E3 | 1.4 | ∘ | 100 |
| | | | | pressure | | | | | |
| | | | | mercury | | | | | |
| | | | | lamp | | | | | |
| Example 24 | — | — | 0 | High- | 3 min | 1.2E3 | 1.5 | ∘ | 100 |
| | | | | pressure | | | | | |
| | | | | mercury | | | | | |
| | | | | lamp | | | | | |
| Example 25 | — | — | 0 | Desk | 60 min | 3.2E3 | 1.5 | ∘ | 100 |
| | | | | light | | | | | |
| Example 26 | — | — | 0 | Indoor | 300 min | 3.3E3 | 1.4 | ∘ | 100 |
| | | | | light | | | | | |
| Example 27 | — | — | 0 | None | — | 3.4E3 | 1.5 | ∘ | 100 |
| Example 28 | — | 0.1 | 3.3 | Desk | 60 min | 5.8E3 | 1.6 | ∘ | 80 |
| | | | | light | | | | | |
| Example 29 | — | — | 0 | Desk | 60 min | 9.2E3 | 1.5 | ∘ | 80 |
| | | | | light | | | | | |
| Example 30 | — | 0.1 | 3.3 | Desk | 60 min | 2.0E3 | 1.1 | ∘ | 82 |
| | | | | light | | | | | |
| Example 31 | — | — | 0 | Desk | 60 min | 3.0E3 | 1.0 | ∘ | 82 |
| | | | | light | | | | | |

As can be seen from Examples 13 to 17 in Table 2, the surface resistance value of the XY film can be sharply reduced by irradiating the titanium-oxide-containing conductive film with a light having energy higher than the band gap of titanium oxide. Furthermore, even if the light for the irradiation is a faint light such as indoor light, the reduction of the surface resistance value by the photoexcitation of titanium oxide is possible. Furthermore, even if titanium oxide is contained in the conductive film, characteristics such as abrasion resistance and transparency are not impaired.

Further, as can be seen from Examples 18 to 22 in Table 2, by containing the titanium oxide source in the low-refraction film forming coating liquid to be coated on the conductive film, titanium oxide can be caused to penetrate into the conductive film, so that the titanium oxide can be contained in the conductive film. Furthermore, even if the light for the irradiation is a faint light such as indoor light, the reduction of the surface resistance value by the photoexcitation of titanium oxide is possible. Furthermore, even if titanium oxide is contained in the conductive film, characteristics such as abrasion resistance and transparency are not impaired.

As can be seen from Examples 23 to 27 in Table 3, the surface resistance value of the XY film can be sharply reduced by irradiating the XY film with a light having energy higher than the band gap of the conductive fine particles.

As can be seen from Examples 28 to 31 in Table 3, also in the XYZ film, the surface resistance value of the XYZ film can be likewise sharply reduced by irradiating the titanium-oxide-containing conductive film with a light having energy higher than the band gap of titanium oxide.

Industrial Applicability

In a low-reflectance conductive film or a colored low-reflectance conductive film formed by the present invention, by containing a resistance-lowering material in the conductive film, the conductivity thereof can be improved, and the impairment of the conductivity with time can be suppressed, and there can be formed such a conductive film that has both transparency and low reflectance performance, while maintaining the reflectance and abrasion resistance.

In particular, by irradiating a conductive film which contains titanium oxide therein with a light having a higher energy than the band gap of titanium oxide, the surface resistance value of the conductive film can be sharply lowered. Furthermore, even if a faint light such as indoor light is used for the irradiation, the reduction of the surface resistance value by the photoexcitation of titanium oxide is possible. Furthermore, even if titanium oxide is contained in the conductive film, characteristics such as abrasion resistance and transparency are not impaired.

The entire disclosures of Japanese Patent Application No. 2001-371347 filed on Dec. 5, 2001 and Japanese Patent Application No. 2002-110511 filed on Apr. 1, 2002 including specifications, claims and summaries are incorporated herein by reference in their entireties.

What is claimed is:

1. A low-reflectance conductive film characterized in that said low-reflectance conductive film comprises at least two films which are a conductive film comprising conductive fine particles and a low-refraction film formed on said conductive film, having a lower refractive index than said conductive film, and that said conductive film comprises a resistance-lowering material.

2. The low-reflectance conductive film according to claim 1, wherein said conductive fine particles are fine particles of tin-doped indium oxide or fine particles of antimony-doped tin oxide.

3. The low-reflectance conductive film according to claim 1, wherein said resistance-lowering material is a sulfur compound and/or titanium oxide.

4. The low-reflectance conductive film according to claim 1, wherein said resistance-lowering material is a sulfur compound, and said sulfur compound is at least one kind selected from the group consisting of α-lipoic acid, α-lipoamide, thiodipropionic acid, sodium thiosulfate, thiourea, and sodium thioglycollate.

5. The low-reflectance conductive film according to claim 1, wherein said resistance-lowering material is a sulfur compound, and the content of said sulfur compound in said conductive film, when converted to the mass of sulfur in said conductive film, is from 0.1 to 10 mass % to the conductive fine particles in the conductive film.

6. The low-reflectance conductive film according to claim 1, wherein said resistance-lowering material is titanium oxide, and the content of said titanium oxide in the conductive film is from 0.1 to 20 mass % to the conductive fine particles in the conductive film.

7. The low-reflectance conductive film according to claim 1, wherein said conductive film has a film thickness of from 5 to 200 nm, and said low-refraction film has a film thickness of from 5 to 150 nm.

8. A colored low-reflectance conductive film according to claim 1, wherein a colored film containing therein a coloring component is formed on a side opposite to the low refraction film of said conductive film.

9. The colored low-reflectance conductive film according to claim 8, wherein said coloring component is carbon black or titanium black.

10. The colored low-reflectance conductive film according to claim 8, wherein said colored film has a film thickness of from 5 to 200 nm.

11. A coated article comprising a substrate on which there is formed said low-reflectance conductive film as defined in claim 1.

12. A display apparatus wherein said coated article as defined in claim 11 is incorporated so as to position said low-reflectance conductive film or said colored low-reflectance conductive film at an external surface thereof.

13. An X-coating liquid comprising a solvent, conductive fine particles, and a resistance-lowering material.

14. A conductive film forming coating liquid as defined in claim 13, wherein the concentration of said conductive fine particles is from 0.01 to 20 mass % to the total mass of said coating liquid, said resistance-lowering material is a titanium oxide source, and the content of said titanium oxide source, when converted to the mass of titanium oxide, is from 0.1 to 20 mass % to the conductive fine particles.

15. A low-refraction film forming coating liquid comprising a solvent, a silicon compound, and a resistance-lowering material.

16. The low-refraction film forming coating liquid according to claim 15, wherein said silicon compound is a silicon alkoxide, with the content of said silicon alkoxide being in an amount of from 0.1 to 30 mass % in terms of the solid component concentration of SiO₂ to the total amount of said low-refraction film forming coating liquid, and said resistance-lowering material is a sulfur compound, with the content of said sulfur compound being in an amount of from 0.01 to 1.5 mass % to the total amount of said low-refraction film forming coating liquid.

17. The low-refraction film forming coating liquid according to claim 15, wherein said silicon compound is a silicon alkoxide, with the content of said silicon alkoxide being in an amount of from 0.1 to 30 mass % in terms of the solid component concentration of Sio₂ to the total amount of said low-refraction film forming coating liquid, and said resistance-lowering material is a titanium oxide source, with the content of said titanium oxide source, when converted into the amount of titanium oxide, being in an amount of from 0.01 to 1.0 mass % to the total amount of said low-refraction film forming coating liquid.

18. A low-reflectance conductive film manufacturing method for forming a low-reflectance film by coating onto a substrate a conductive film forming coating liquid which contains conductive fine particles, and then coating a low-refraction film forming coating liquid which contains a resistance-lowering material.

19. A colored low-reflectance film manufacturing method according to claim 18 for forming a colored low-reflectance film by coating onto a substrate a colored film forming coating liquid which contains a coloring component, prior to the coating of said conductive film forming coating liquid.

20. A low-reflectance conductive film manufacturing method characterized by coating onto a substrate a conductive film forming coating liquid which contains conductive fine particles, then coating a low-refraction film coating liquid, thereby forming a low-reflectance conductive film, and irradiating said low-reflectance conductive film with a light having energy greater than the band gap of said conductive particles, thereby reducing the surface resistance value of said low-reflectance film in comparison with the case where the irradiation of said light is not carried out.

21. A low-reflectance conductive film manufacturing method for forming a low-reflectance conductive film by coating onto a substrate a conductive film forming coating liquid which contains conductive fine particles, then coating a low-refraction film forming coating liquid, thereby forming the low-refraction film, characterized in that said conductive film forming coating liquid and/or said low-refraction film forming coating liquid contains a titanium oxide source, and the surface resistance value of said low-reflectance film is reduced by irradiating said low-reflectance conductive film with light having energy greater than the band gap of titanium oxide, in comparison with the case where the irradiation of said light is-not carried out.
